(19) United States
(12) Patent Application Publication
(10) Pub. No.: US 2021/0162503 A1
(43) Pub. Date: Jun. 3, 2021

(54) Producing a Component by the Application of Particle-Filled Discrete Volume Elements

(71) Applicant: Siemens Aktiengesellschaft, München (DE)

(72) Inventor: Carsten Schuh, Baldham (DE)

(73) Assignee: Siemens Aktiengesellschaft, München (DE)

(21) Appl. No.: 17/268,182

(22) PCT Filed: Aug. 16, 2019
(86) PCT No.: PCT/EP2019/072009

§ 371 Date: Feb. 12, 2021

(30) Foreign Application Priority Data
Aug. 21, 2018 (EP) 18189844.6

(51) Int. Cl. B22F 10/18; B33Y 10/00; B28B 1/00; B29C 64/118

(52) U.S. Cl. CPC B22F 10/18; B29C 64/118; B28B 1/001; B33Y 10/00

(57) ABSTRACT

Various embodiments include a method for producing a component including: producing a green body from a starting material comprising metal particles and/or ceramic particles by applying a respective portion of the starting material using a nozzle, onto a substrate or a previously applied portion of the starting material in temporally successive steps; and thermally treating the green body. Each of the temporally successive steps includes applying the starting material in the form of discrete volume elements. Each of the respective volume elements in a given step has the same volume.

### CROSS-REFERENCE TO RELATED APPLICATIONS

This application is a U.S. National Stage Application of International Application No. PCT/EP2019/072009 filed Aug. 16, 2019, which designates the United States of America, and claims priority to EP Application No. 18189844.6 filed Aug. 21, 2018, the contents of which are hereby incorporated by reference in their entirety.

### TECHNICAL FIELD

The present disclosure relates to manufacturing. Various embodiments may include methods for producing a component, in which a starting material is provided which comprises metal particles and/or ceramic particles.

### BACKGROUND

Interest is directed toward the production of components and in particular toward the production of complex three-dimensional structures. In particular, the component may be manufactured from a metal (alloy), a ceramic and/or a composite material. Some manufacturing methods begin by producing a green body, which is subsequently thermally treated, from said particle-filled starting material.

In this connection, different additive manufacturing processes are suitable for generating three-dimensional components or bodies by way of the production of a green body from particle-filled thermoplastic compositions or slips with subsequent sintering. By way of example, lithography-based ceramics manufacturing begins with, analogously to stereolithograhy, radical polymerization of a binder system using light of a defined wavelength, as a result of which a suspension is solidified.

So-called melt extrusion allows, for example, thermoplastic compositions, feedstocks and/or filaments to be processed. Here, a thermoplastic composition is transferred into a flowable state by supply of heat and deposited at the desired point. There, the composition solidifies immediately again during cooling.

3D extrusion or so-called robocasting allows cold viscous or plastic compositions to be extruded and deposited via a nozzle. In this case, either compositions based on natural raw materials, for example porcelain, clay or the like, can be processed.

As an alternative thereto, use can be made of compositions based on synthetic raw materials, in which the plasticity is obtained by way of organic additives. In this process, a continuous strand is deposited in paths along the component geometry. Direct 3D printing by means of suspensions is also known. In this case, it is possible to print for example (nano)particle-filled inks. In addition, so-called aerosol-based processes are known.

Finally, lamination processes include constructing a shaped body by way of layerwise lamination. Here, after application, each layer is cut to size in accordance with a model specification. Only then is the next layer applied.

### SUMMARY

The teachings of the present disclosure demonstrate a solution as to how the production of a component, in particular of a complex three-dimensional component, can be improved. For example, some embodiments include a method for producing a component (4), having the steps of: providing a starting material (2) which comprises metal particles and/or ceramic particles, producing a green body (3) from the starting material (2), wherein, for the production of the green body (3), a respective portion of the starting material (2) is applied, by means of a nozzle (1), to a substrate (5) and/or to a previously applied portion of the starting material (2) in temporally successive steps, and thermally treating the green body (3) produced, characterized in that, in the temporally successive steps, the starting material (2) is applied in each case in the form of discrete volume elements (7), wherein the respective volume elements (7) have the same volume, and the respective volume elements (7) are placed on the substrate (5) and/or on a previously applied volume element (7).

In some embodiments, by way of the placing of the volume elements (7) onto the substrate (5) and/or onto the previously applied volume element (7), the green body (3) is produced with a three-dimensional form.

In some embodiments, the starting material (2) comprises a solvent, and the starting material (2) is conveyed through the nozzle.

In some embodiments, the starting material (2) comprises a thermoplastic material, and the starting material (2) is heated and/or plastified for conveyance through the nozzle (1).

In some embodiments, the starting material (2) is provided in the form of filament.

In some embodiments, the volume element (7) is connected in a form-fitting manner to the substrate (5) and/or the already applied volume element (7) during the placing-on operation.

In some embodiments, the volume element (7) is plastically deformed after the placing-on operation.

In some embodiments, for the placing-on of the volume element (7), the portion of the starting material (2) is separated from the nozzle (1).

In some embodiments, a surface of the substrate (5) and/or of the already applied volume element (7) is pre-treated prior to the placing-on of the volume element (7).

In some embodiments, after the placing-on of at least one volume element (7), cooling and/or drying is carried out by means of a gas stream.

### BRIEF DESCRIPTION OF THE DRAWINGS

The teachings herein are explained in more detail on the basis of exemplary embodiments and with reference to the attached drawings, in which:

FIG. 1 is a drawing showing a schematic illustration of a nozzle of a printing device, by means of which nozzle a volume element is deposited, from a starting material, on a substrate; and

FIG. 2 shows a plurality of volume elements deposited on one another, which form a green body.

In the figures, functionally identical elements are provided with the same reference designations.

### DETAILED DESCRIPTION

A method taught herein may be used to produce a component. The example methods comprise the provision of a starting material which comprises metal particles and/or ceramic particles. The methods also comprise the production of a green body from the starting material. For the production of the green body, a respective portion of the starting material is applied, by means of a nozzle, to a substrate and/or to a previously applied portion of the starting material in temporally successive steps. Subsequent thereto, the green body produced is thermally treated. In this case, in temporally successive steps, the starting material is applied in each case in the form of discrete volume elements, wherein the respective volume elements have the same volume. In addition, the respective volume elements are placed on the substrate and/or on a previously applied volume element.

By means of the methods described herein, the intention is to produce a component and in particular a complex three-dimensional component. The component can in particular be a part of an electrical or electronic component. By way of example, the component can be a constituent part of an electric machine, of a transformer, of an electronics component or the like. For the production of the component, the starting material is initially provided. The starting material comprises metal particles and/or ceramic particles.

A particle-filled starting material is thus provided. Provision can also be made for the starting material to comprise particles of a metal alloy and/or of a composite material. For the production of the green body, the starting material is used. For this purpose, the starting material is conveyed through a nozzle or deposited by means of a nozzle. In this case, the starting material can be applied to the substrate or a corresponding carrier element. Here, the starting material or respective portions of the starting material is/are deposited in a plurality of temporally successive steps. In the respective steps, the starting material is deposited above one another and/or next to one another, and therefore the three-dimensional green body is formed. Subsequently thereto, the green body is thermally treated. In some embodiments, provision is made for so-called debinding and sintering to be performed in order to produce the component.

In some embodiments, discrete volume elements to be deposited in each case in the temporally successive steps by means of the nozzle. In some embodiments, said volume elements to have the same volume. In some embodiments, the respective volume elements are also placed on the substrate and/or on already applied volume elements. In the production process, discrete volume elements are thus deposited successively. Said volume elements are configured such that they each have the same volume or the same size. In some embodiments, the volume elements have the same form. The respective volume elements can for example be substantially cuboidal, spherical, cylindrical, or the like. In some embodiments, the starting material is not applied along defined paths. The respective volume elements can be deposited successively at predetermined positions.

In some embodiments, the respective volume elements may be placed on. In comparison with printing processes in which a liquid starting material is sprayed onto a substrate, a paste-like or viscous starting material may be discharged in the form of a volume element. During the discharging operation, the volume element contacts both the substrate or the already previously applied volume element and/or the nozzle. By way of example, during the application, there may be a force-fitting connection between the starting material and the nozzle.

In some embodiments, the starting material may be applied in a non-contactless manner with the nozzle. The green body can then be formed from the discrete volume elements and, subsequently thereto, treated or subjected to debinding and sintering. The methods described herein differ from known additive manufacturing processes or from known 3D printing processes in particular by the manner in which the individual volume elements, which can also be referred to as material pixels, are generated. The distribution of the volume elements, the targeted shaping of the volume elements and the deposition of the volume elements make it possible to achieve a high degree of detail accuracy. An improved surface quality with low roughness and separation sharpness can also be obtained.

By way of the placing of the volume elements onto the substrate and/or onto the previously applied volume element, the green body may be produced in a three-dimensional form. The green body can be produced using a corresponding printing apparatus which has the nozzle. In some embodiments, the printing apparatus have a plurality of nozzles. In this case, the nozzle can be moved relative to the substrate. Said nozzle may be movable in a translational manner along two or three spatial directions. In some embodiments, the nozzle may be able to be rotated along the spatial directions. The additive manufacturing operation is thus possible in all three spatial directions, and not only in the form of a planar layer structure.

In some embodiments, the starting material comprises a solvent, and the starting material is conveyed through the nozzle. In other words, the starting material can be a so-called slip, which comprises a corresponding solvent in addition to the particles. Said solvent can be aqueous or organic. Said starting material or the slip can thus be conveyed by means of the printing apparatus and can be dispensed or extruded out of the nozzle. Such a suspension or such a slip can be produced in a cost-effective manner in comparison with corresponding particle-filled nano-inks. There is also a wide adaptability of the particle-filled suspension with regard to the rheology and the filling level. The generation of the volume elements and their deposition are also influenced little in comparison with inks.

In some embodiments, the starting material comprises a thermoplastic material. In some embodiments, the starting material may be a thermoplastic material. The starting material may be also heated and/or plastified for conveyance through the nozzle. The starting material can be a so-called feedstock, that is to say a particle-filled thermoplastic composition without a solvent. For the provision of the volume element, said feedstock can be heated and/or plastified at least in certain regions. For this purpose, a corresponding heating device of the printing apparatus can be used. In some embodiments, the nozzle may have a corresponding heating device. In some embodiments, pressure may be applied to the starting material. A starting material in the form of a feedstock can also be provided in a cost-effective manner. Here, the advantages as a result of the adaptability of the material properties are also produced.

In some embodiments, the starting material is provided in the form of particle-filled filament. In other words, the starting material can thus be provided in the form of a fiber or of a wire. In some embodiments, the starting material in the form of the filament may be correspondingly heated or plastified for provision of the volume element. In some embodiments, a portion of the filament may be separated for provision of the volume element. The green body can thus be produced in a precise manner with little effort.

The production method can also be correspondingly scaled. In order to produce large components or green bodies, larger volume elements can be provided. For this purpose, it is for example possible for the shaping of the nozzle to be correspondingly adapted. The size of the particles can also be adapted. In some embodiments, filaments having a greater diameter may be used, for example. In addition, the method can also be scaled toward the production of microcomponents. By way of example, correspondingly smaller nozzles can be used here. With the starting material used, the flow dynamics have no, or only little, influence in comparison with liquid materials. In principle, the particle-filled starting material also makes it possible to realize greater construction volumes on account of the high intrinsic stiffness of the green body generated.

In some embodiments, the volume element is connected in a form-fitting manner to the substrate and/or the already applied volume element during the placing-on operation. The respective volume elements can thus be arranged on one another and/or next to one another such that the respective volume elements are connected to one another in a form-fitting manner. In other words, a form fit of the volume element of the already constructed structure is generated. In this way, after the thermal treatment of the green body or after the sintering, it is possible to achieve a reduced porosity. This means that a dense, homogeneous microstructure is produced after the sintering.

In some embodiments, during the placing-on operation, the volume element is pushed onto the substrate and/or the already applied volume element with a predetermined force. By way of example, prior to the separating operation, a portion of the starting material that forms the volume element can be correspondingly compressed, or can be pushed into the already present structure, by way of the nozzle. As a result, the density of the starting material or of the volume element can be increased and thus porosity reduced. For this purpose, during the conveyance of the starting material, the nozzle can for example be moved toward the substrate and/or the already dispensed volume element as soon as that portion of the starting material which forms the volume element has exited out of the nozzle.

In some embodiments, the volume element is plastically deformed after the placing-on operation. To this end, it is for example possible for a separate tool to be used, with which the shaping of the volume element is altered after the placing-on operation. Further design possibilities are thus produced in the production of the green body. In some embodiments, the nozzle or a part thereof may be used for the plastic deformation of the applied volume element. The form of the deposited volume element can also be influenced by the shaping of the nozzle. By way of example, the nozzle can have a round, an elliptical or rectangular cross section.

In some embodiments, for the placing-on of the volume element, the portion of the starting material may be separated from the nozzle. The starting material can be conveyed through the nozzle, and therefore the starting material or the portion of the starting material exits out of the nozzle, but the starting material is still in contact with the nozzle. In order to separate the starting material from the nozzle, a corresponding separation device can be used. The separation device can for example be a corresponding wire, a blade or the like. Provision can also be made for the starting material to be locally heated for separation purposes. In order to heat and/or plastify the starting material, use can for example be made of infrared radiation, an inductive heating device, a laser or the like. In some embodiments, the nozzle may be moved correspondingly for separation of the starting material. By way of example, the volume element can be separated by way of corresponding stretching and/or overstretching of the starting material. This permits precise production of the respective volume elements overall.

In some embodiments, after the placing-on of at least one volume element, cooling and/or drying is carried out by means of a gas stream. Said cooling and/or drying can be carried out after the deposition of each individual volume element. Provision can also be made for the cooling and/or drying to be carried out after a predetermined number of volume elements or all of the volume elements have been deposited. For the cooling and/or drying, use can be made of a (cold) gas stream which is directed locally onto the volume elements or the green body. In this way, the cooling and/or drying can be forced.

In some embodiments, at least one further starting material to be used for the production of the green body. The further starting material can also comprise metal particles and/or ceramic particles. In principle, a plurality of starting materials may be used for the production of the green body. Said starting materials can differ from one another with regard to the type of particles and/or the concentration of the particles. It is thus made possible, for example, for the green body to be able to be produced with a gradation or different concentrations and/or volume proportions of the particles.

Further features of the teachings herein emerge from the claims, from the figures and from the description of the figures. The features and feature combinations mentioned above in the description, and the features and feature combinations mentioned below in the description of the figures and/or only shown in the figures, may be used not only in the respectively specified combination but also in other combinations, without departing from the scope of the disclosure.

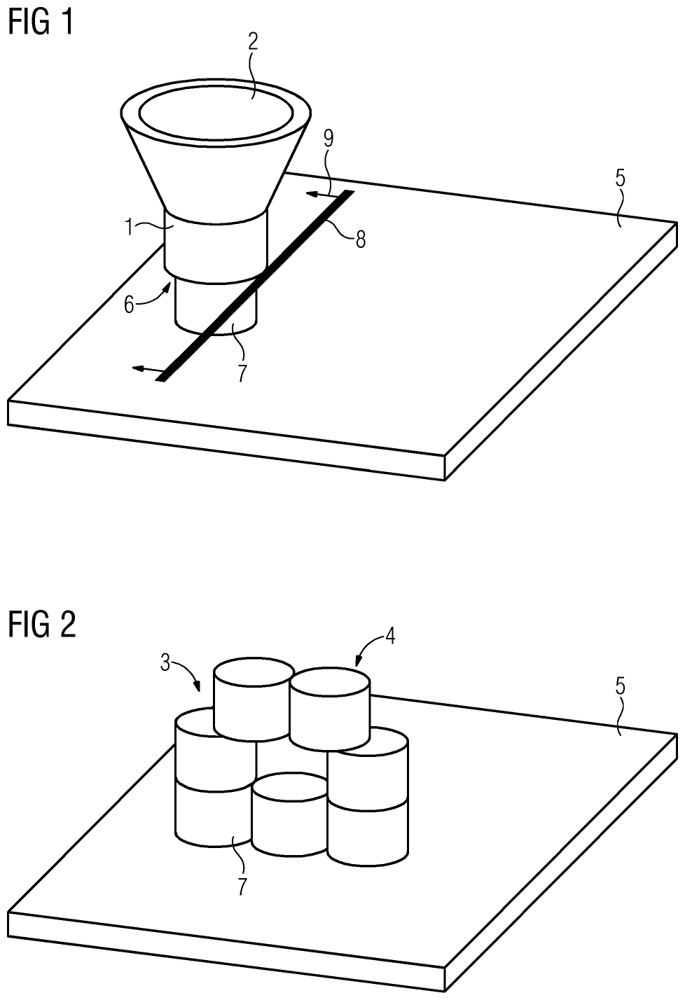

FIG. 1 shows a greatly simplified illustration of a nozzle 1, by means of which a starting material 2 can be deposited. The starting material 2 is a material which comprises metal particles and/or ceramic particles. In some embodiments, the starting material comprises particles of a metal alloy and/or of a composite material. The intention is for a green body 3 to initially be manufactured from said starting material 2 and for a component 4 to subsequently be produced.

In some embodiments, the starting material 2 can be provided in the form of a slip or suspension. In this case, the starting material 2 comprises, in addition to the metal particles and/or ceramic particles, a solvent which can be aqueous or organic. The starting material 2 can be paste-like and have a predetermined viscosity. The starting material used can also be a so-called feedstock, wherein in this case the starting material 2 additionally comprises a thermoplastic material. In some embodiments, the starting material may be in the form of a filament. Said starting material 2 is conveyed by means of the nozzle 1 in order to be applied to a substrate 5. Here, the starting material has a predetermined viscosity. As can be seen in the present case in FIG. 1, the starting material 2 exits at an outlet opening 6 and remains in contact with the nozzle 1 here.

In the printing process, discrete volume elements 7 are provided in each case in temporally successive steps. In the method, said volume elements 7 are initially placed onto the substrate 5. With the further steps, the volume elements 7 can be placed onto the substrate 5 and/or onto already applied volume elements 7. In this case, the respective volume elements 7 have the same volume. In the present embodiment, the volume elements 7 are of cylindrical form. Said shaping is produced by the form of the nozzle 1. The volume elements 7 can also have another form.

During the placing-on of the respective volume elements 7, said elements can be pushed, by means of the nozzle 1, against the substrate 5 and/or the already placed-on volume elements 7 with a predetermined force. In order to apply the volume elements 7, the starting material which has exited out of the outlet opening 6 of the nozzle can be separated by means of a separation device 8. In the present case, a separation device 8 in the form of a wire is schematically illustrated, said wire being able to be moved along the direction of the arrows 9 in order to separate the starting material 2 which exits out of the nozzle 1 from the nozzle 1 and thus to apply the volume element 7.

By way of example, FIG. 2 shows a plurality of volume elements 7 which have been deposited next to one another and above one another on the substrate 5. Here, provision can be made for the surface of the substrate 5 and/or of the already deposited volume element 7 to be correspondingly pre-treated prior to the deposition of the respective volume element 7. By way of example, pre-heating or dissolution can be performed. In the case of a starting material in the form of a slip, corresponding humidification can be performed. In particular, the respective volume elements 7 are applied in such a way that they have a form fit with respect to one another. Provision can also be made for the respective volume elements 7 to be correspondingly plastically deformed after the application operation. In addition, after the deposition of the volume elements, forced cooling and/or drying can be provided by way of a local gas stream.

The respective volume elements 7 form a three-dimensional green body 3. In order to be able to produce the component 4, said three-dimensional green body 3 can be correspondingly thermally treated. In some embodiments, so-called debinding and sintering may be performed.

As a result of the division of the starting material into the volume elements 7, which can also be referred to as material pixels, a targeted forming of the volume elements 7, a separation from the material transport, and the shaping and/or deposition of the volume elements 7 can be achieved with a high degree of detail accuracy. In particular, it is possible to obtain a high surface quality with a low roughness and a separation sharpness. The deposition of the material pixels or volume elements 7 in the form fit, including the optional additional plastic compression, makes it possible to increase the green density of the green body 3 and thus reduce porosities. In the component 4, a dense, homogeneous microstructure is therefore produced after the sintering. It is also possible for the application of the volume elements 7 or of the material to be performed at a high rate. The advantage of the use of cost-effective, time-stable suspensions and/or feedstocks is also produced. Moreover, there is a wide adaptability of the particle-filled starting material with regard to rheology and filling level. Furthermore, the method can be scaled in a corresponding manner.

What is claimed is:

1. A method for producing a component, the method comprises:
producing a green body from a starting material comprising metal particles and/or ceramic particles by applying respective portion of the starting material using a nozzle, onto a substrate or a previously applied portion of the starting material in temporally successive steps; and
thermally treating the green body;
wherein each of the temporally successive steps includes applying the starting material in the form of discrete volume elements, wherein each of the respective volume elements in a given step has the same volume.

2. The method as claimed in claim 1, wherein placing the volume elements provides a green body having a three-dimensional form.

3. The method as claimed in claim 1, wherein:
the starting material comprises a solvent; and
the starting material is conveyed through the nozzle.

4. The method as claimed in claim 1, wherein:
the starting material comprises a thermoplastic material; and
the starting material is heated and/or plastified for conveyance through the nozzle.

5. The method as claimed in claim 1, wherein the starting material has the form of filament.

6. The method as claimed in claim 1, wherein each respective volume element is connected in a form-fitting manner to the substrate or an already applied volume element.

7. The method as claimed in claim 1, wherein each respective volume element is plastically deformed after being placed.

8. The method as claimed in claim 1, wherein placing a respective volume element includes separating a portion of the starting material from the nozzle.

9. The method as claimed in claim 1, further comprising preparing a surface of the substrate or a surface of a previously applied volume element prior to placing a subsequent volume element.

10. The method as claimed in claim 1, further comprising, after placing a volume element, cooling and/or drying the volume element using a gas stream.
